(19) United States
(12) Patent Application Publication
(10) Pub. No.: US 2011/0036818 A1
(43) Pub. Date: Feb. 17, 2011

(54) OPTICAL ETCHING DEVICE FOR LASER MACHINING

(75) Inventors: Chih-Kung Lee, Taipei City (TW); Jyi-Tyan Yeh, Taipei City (TW); Ding-Zheng Lin, Taipei City (TW); Tsung-Dar Cheng, Taipei City (TW); Chin-Kai Chang, Taipei City (TW)

Correspondence Address: QUINTERO LAW OFFICE, PC, 615 Hampton Dr, Suite A202, Venice, CA, 90291, US

(73) Assignee: NATIONAL TAIWAN UNIVERSITY, Taipei (TW)

(21) Appl. No.: 12/774,642

(22) Filed: May 5, 2010

(30) Foreign Application Priority Data
Aug. 13, 2009 (TW) TW098127218

(51) Int. Cl. B23K 26/00

(52) U.S. Cl. 219/121.69

(57) ABSTRACT

An optical etching device for laser machining is provided and includes a laser light source and an optical head. The laser light source emits an incident beam. The optical head includes a transparent substrate, an opaque film and a sub-wavelength annular channel. The laser energy tolerance of the transparent substrate ranges from 8 J/cm² to 12 J/cm². The opaque film has a first surface and a second surface opposite to the first surface. The transparent substrate is adhered to the first surface. The sub-wavelength annular channel is formed in the opaque film and extends from the first surface to the second surface so that the incident beam from the transparent substrate generates a surface plasma wave on the opaque film.

### CROSS REFERENCE TO RELATED APPLICATIONS

This Application claims priority of Taiwan Patent Application No. 098127218, filed on Aug. 13, 2009, the entirety of which is incorporated by reference herein.

### BACKGROUND OF THE INVENTION 1. Field of the Invention

The present invention relates to an optical etching device, and in particular relates to an optical etching device for laser machining.

2. Description of the Related Art

Focus point size provided by an optical lens is mainly decided by diffraction limit. Specifically, due to properties of light, including interference and diffraction, focus point size provided by an optical lens is decided by the wavelength of incident beam and a numerical aperture, NA of the lens in the far-field region. Because of diffraction limit, a focus point in the far field is half of a wavelength of an incident beam. Thus, for a small focus point, a lens with greater NA is required. However, using an optical lens with greater NA decreases depth of focus. During exposure and etching process, lens with short depth of focus needs an accurate platform control.

In addition to conventional optical lenses, a sub-wavelength metal structure may be used to modulate a light field. Ebbesen disclosed a transparent circumstance in 1998. A single sub-wavelength hole was disposed on a metal film. If a periodic sub-wavelength structure with a sub-wavelength size around the hole, the energy of the single sub-wavelength hole increased. The periodic sub-wavelength structure was comprised of a concentric circular surface structure or a sub-wavelength slot with a surface grating on two thereof. When the periodic sub-wavelength structure was disposed on an outside surface of the hole, an outgoing beam passing through the hole was affected by the surface structure to make energy spread at a specific outgoing angle. Thus, a directional outgoing beam was provided.

J. Durnin disclosed a Bessel beam in 1987. Compared with a Gauss beam, the Bessel beam does not dissipate with distance during transmission. Theoretically, the depth of focus of a Bessel beam is infinite. Bessel beams may be generated by different devices, for example, a laser beam on a ring cover on a focal plane of a lens or on a cone-shaped lens or a holographic element. The Bessel beam is formed in an area behind the lens. However, sizes of elements of the devices are similar to those of traditional elements. Moreover, nanometer stage cone-shaped lens is used to generate a Bessel beam. A ring cover is put on a focus plane for generating a focus Bessel beam. However, an additional lens is added behind the ring cover, thus, the whole optical system volume is difficult to be minified. To use a single ring to be a cover make a beam generate interference with another Gauss beam for generating a Bessel beam. Sizes of elements of conventional devices are traditional sizes.

Taiwan Patent publication No. 200848785 ‘optical head’ has disclosed a micro-optical head. The optical head provides enough depth of focus for a sub-wavelength light point. However, conventional optical head material can not bear laser energy, resulting in a transparent substrate and an opaque film broken and decreasing efficiency of the optical head.

### BRIEF SUMMARY OF THE INVENTION

The present invention provides an optical etching device for laser machining including a laser light source and an optical head. The laser light source emits an incident beam. The optical head transforms the incident beam into a sub-wavelength beam for processing an object. The optical head includes a transparent substrate, an opaque film and a sub-wavelength annular channel. The laser energy tolerance of the transparent substrate ranges from 8 J/cm² to 12 J/cm². The opaque film has a first surface and a second surface opposite to the first surface. The transparent substrate is adhered to the first surface. The sub-wavelength annular channel is formed in the opaque film and extends from the first surface to the second surface so that the incident beam from the transparent substrate generates a surface plasma wave on the opaque film.

Note that when the wavelength of the incident beam ranges from 100 nm to 400 nm, the light transmission of the transparent substrate is greater than 70 percents.

Note that the transparent substrate comprises melted quartz and melted sapphire blending SiO2.

Note that the laser energy tolerance of the opaque film ranges from 8 J/cm² to 12 J/cm².

Note that the opaque film comprises a silver film.

Note that the optical etching device further comprises a movable platform to change the relative position of the optical head and a photoresist layer of the object.

Note that the sub-wavelength annular channel is ring-shaped.

Note that the width of the sub-wavelength annular channel is 0.05 to 0.95 times the wavelength of the incident beam.

Note that the optical etching device further comprises at least a ring groove disposed on the inner side of the sub-wavelength annular channel on the opaque film, wherein the surface plasma wave generates light in the ring groove.

Note that the sub-wavelength annular channel and the ring groove comprise a common center.

Note that the ring groove is ring-shaped.

Note that the depth of the ring groove is 0.05 to 0.5 times the wavelength of the incident beam.

Note that the relative dielectric constant of the opaque film ranges from −2 to −32.

Note that the relative dielectric constant of the opaque film ranges from +1.5 to +16.

Note that the relative dielectric constant of the transparent substrate ranges from +1.5 to +16.

Note that the thickness of the opaque film is 0.25 to 2 times the wavelength of the incident beam.

### BRIEF DESCRIPTION OF THE DRAWINGS

FIG. 1 is a schematic view of an optical etching device for laser machining of the invention;

FIG. 2 is a sectional view of an optical etching device for laser machining of the invention;

FIG. 3 is a schematic view showing a optical etching device applied in laser machining;

FIG. 4 is a schematic view of a sub-wavelength annular channel of another embodiment of the invention; and

FIG. 5 is a sectional view of a sub-wavelength annular channel of another embodiment of the invention.

A detailed description is given in the following embodiments with reference to the accompanying drawings.

### DESCRIPTION OF THE INVENTION

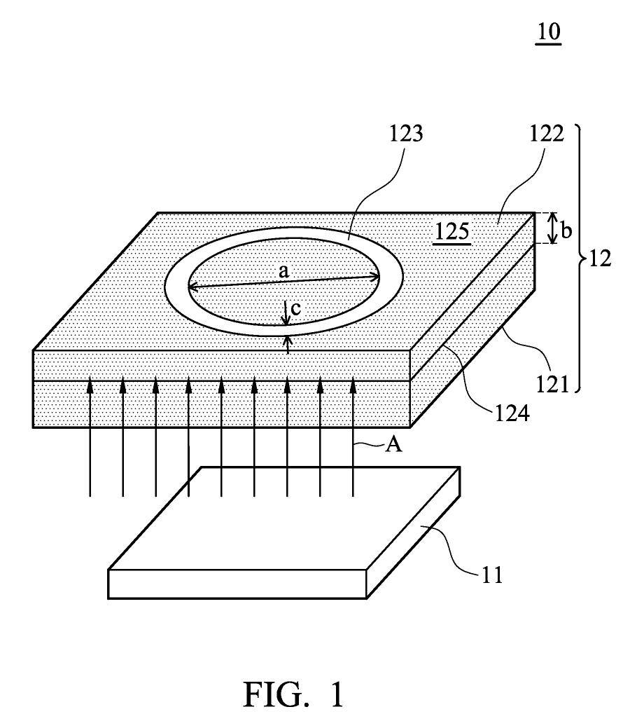

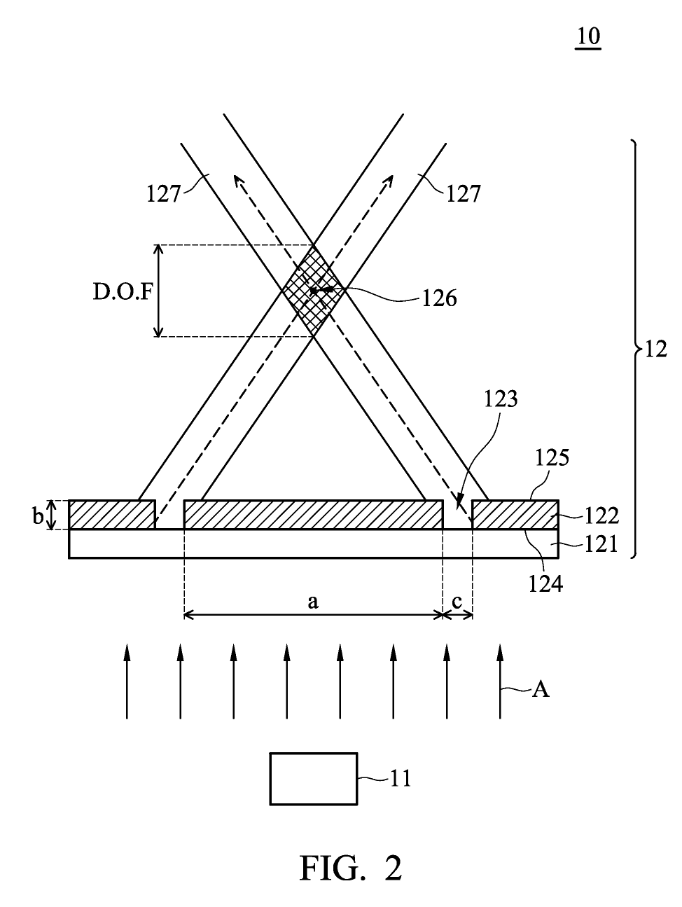

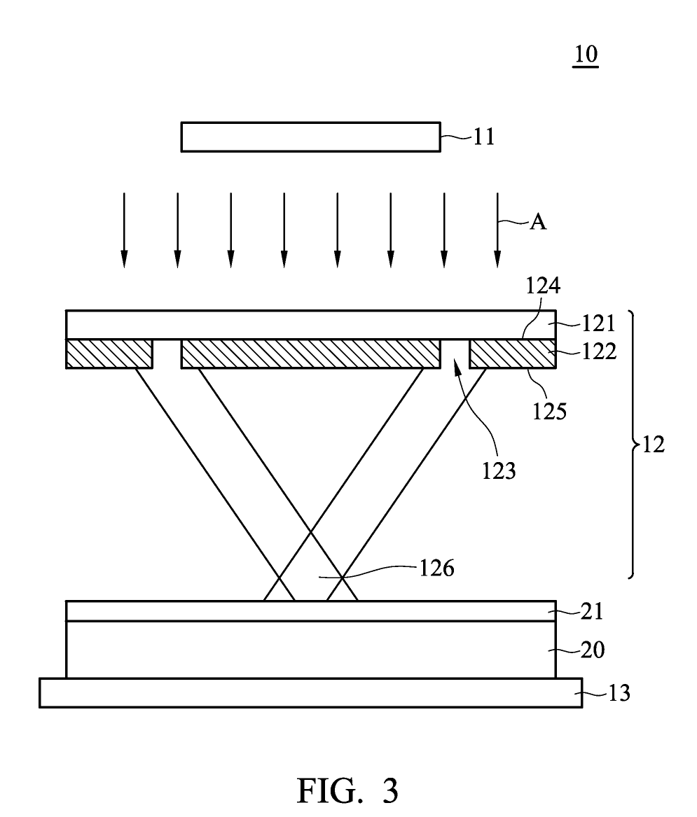

FIG. 1 is a schematic view of an optical etching device for laser machining of the invention. FIG. 2 is a sectional view of an optical etching device for laser machining of the invention. FIG. 3 is a schematic view showing an optical etching device applied in laser machining.

Referring to FIGS. 1 to 3, an optical etching device 10 for laser machining comprises a laser source 11 and an optical head 12. The laser light source 11 emits an incident beam A. The incident beam A is a laser beam with high energy. The optical head 12 transforms the incident beam A into a sub-wavelength size beam. An object is exposed and developed via energy of the sub-wavelength size beam.

The optical head 12 comprises a transparent substrate 121, an opaque film 122 and a sub-wavelength annular channel 123. The laser energy tolerance of the transparent substrate 121 ranges from 8 J/cm² to 12 J/cm². The opaque film 122 has a first surface 124 and a second surface 125 opposite to the first surface 124. The transparent substrate 121 is adhered to the first surface 124. The sub-wavelength annular channel 123 is formed in the opaque film 122 and extends from the first surface 124 to the second surface 125 so that the incident beam A from the transparent substrate 121 to the opaque film 122 generates a surface plasma wave on the opaque film 122. When the wavelength of the incident beam A ranges from 100 nm to 400 nm, the light transmission of the transparent substrate 121 is greater than 70 percents.

In this embodiment, the transparent substrate 121 comprises melted quartz and melted sapphire blending SiO2. However, transparent materials to resist laser energy of the incident beam A can be used, and the invention is not limited to the disclosed embodiments. Because the optical etching device 10 is applied in a laser process, the transparent substrate 121 and the opaque film 122 must tolerate laser energy, and not be damaged by it. Thus, laser energy tolerance of the opaque film 122 ranges from 8 J/cm² to 12 J/cm². In this embodiment, the opaque film 122 comprises a silver film. Transparent materials to resist laser energy of the incident beam A can be used, and the invention is not limited to the disclosed embodiments. The sub-wavelength annular channel is ring-shaped.

Referring to FIG. 3, the optical etching device 10 further comprises a movable platform 13. The movable platform 13 changes the relative position of the optical head 12 and a photoresist layer 21 of the object 20, thus, making process more convenient. The optical etching device 10 provides a light point with a wavelength and a focus point with long depth of focus to make the incident beam A (Laser) focus on the photoresist layer 21 for the laser process and define a pattern with a high aspect ratio. The object 20 is a wafer disposed on the movable platform 13. When moving the movable platform 13, the relative position of the object 20 and the optical head 12 is changed, thus, making process more convenient.

In this embodiment, the size of the smallest light point, the depth of focus DOF and the position of the focus light point 126 are defined by the diameter a of the sub-wavelength annular channel 123, the thickness b of the opaque film 122 and the width c of the sub-wavelength annular channel 123.

The transparent substrate 121 supports the opaque film 122 but does not block the incident beam A. The opaque film 122 blocks the incident beam A. Thus, the incident beam A only passes through the sub-wavelength annular channel 123 on the opaque film 122. In a specific mode, energy is generated on an outlet. The sub-wavelength annular channel 123 modulates a transparent light field 127. The opaque film 122 controls the mode of the incident beam A in the sub-wavelength annular channel 123. Most of the energy is uniformly spread in an area, and size of the area is equal to the sub-wavelength. A specific mode is formed in the sub-wavelength annular channel 123 by adjusting the thickness b of the opaque film 122 to generate a specific wave sending angle. The focus light point 126 generated by the optical head 12 is equal to ¾ wavelength. The depth of focus DOF is several decuple wavelengths.

At least a sub-wavelength annular channel 123 is formed on the opaque film 122 on the optical head 12. The path of each outgoing beam is decided by the thickness b of the opaque film 122. The thickness b ranges 0.25 to 2 wavelengths of the incident beam A. The thickness b of the opaque film 122 affects the strength of the transparent light field 127, preventing the incident beam A from direct penetration. Thus, any size of thickness b may be chosen, as long as the above function is accomplished, and is not limited.

The diameter of the sub-wavelength annular channel 123 affects the intersecting position of the outgoing beams. The greater the diameter a of the sub-wavelength annular channel 123, the further the intersecting position of the outgoing beams. However, direction is not affected. According to experimental result, the radius a/2 of the sub-wavelength annular channel 123 ranges from 10 to 30 wavelengths of the incident beam A to effectively generate the sub-wavelength focus light point. However, the invention is not limited to the disclosed embodiments.

The diameter of the sub-wavelength annular channel 123 also affects the position of the focus light point 126 in the optical head 12 and the position of the depth of focus DOF. The greater the diameter a of the sub-wavelength annular channel 123, the deeper the depth of focus of the light point (shown in FIG. 2, the position where outgoing beams intersecting). Normally, the diameter a of the sub-wavelength annular channel 123 ranges from 10 to 30 wavelengths of the incident beam A, but the invention is not limited to the disclosed embodiments.

Material of the opaque film 122 of the optical head 12 and the relative dielectric constant affects the mode in the sub-wavelength annular channel 123 and energy For example, the silver ring is an HE mode (mixing TM mode and the TE mode). The tungsten ring is a TEₘ₁ mode. Material of the opaque film 122 of the optical head 12 may be metal material (with relative dielectric constant ranges from −2 to −32) or non-metal material (with relative dielectric constant ranges from +1.5 to +16). Note that metal material or non-metal material must resist the incident beam A (laser) to prevent material damage. The relative dielectric constant of the transparent substrate 121 ranges from +1.5 to +16.

The width of the sub-wavelength annular channel 123 of the optical head 12 is 0.05 to 0.95 times the wavelength of the incident beam A.

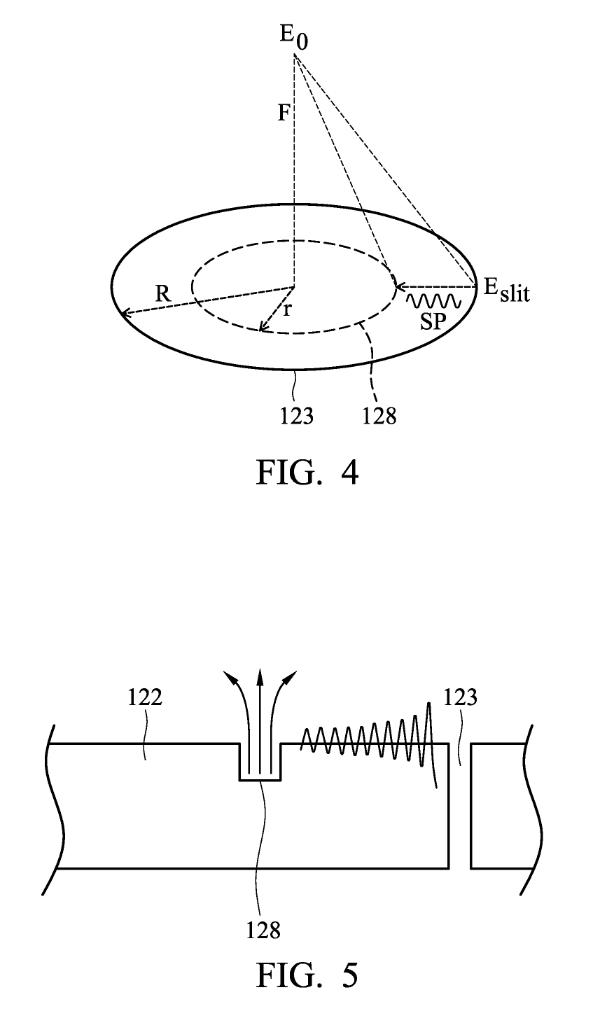

FIG. 4 is a schematic view of a sub-wavelength annular channel of another embodiment of the invention. FIG. 5 is a sectional view of a sub-wavelength annular channel of another embodiment of the invention.

Referring to FIGS. 2 and 4-5, a ring groove 128 is disposed on the opaque film 122 of the optical head 12. Shown in the figures, the ring groove 128 can increase energy of the focus light point 126 (Referring to FIG. 2). The depth of the ring groove 128 affects the phase of scattering light. The depth of the ring groove 128 is 0.05 to 0.5 times the wavelength of the incident beam A.

FIG. 4 shows an RCG (Ring containing Circular) nanometer metal structure. When the incident beam A passes through the sub-wavelength annular channel 123, a surface plasma wave is generated on the metal surface, and the surface plasma wave is coupled to transform a beam to scatter to a far field to increase energy. The radius of the sub-wavelength annular channel 123 is R, and the radius of the ring groove 128 is r. As shown in FIG. 4, the sub-wavelength annular channel 123 and the ring groove 128 have a common center.

Shown in FIG. 4, after the incident beam A passes through the sub-wavelength annular channel 123, the incident beam A is divided into two parts. One part is a beam to directly arrive at the far field. The other is surface plasma transmitted on the metal surface. If a ring is installed around a ring slot, the original surface plasma is scattered to the far field to increase energy.

In summary, the invention provides an optical etching device for laser machining, and the optical etching device provides a sub-wavelength light point and has increased depth of focus and a simple structure when compared to conventional devices.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical etching device for laser machining, comprising:
a laser light source, radiating an incident beam; and
an optical head, transforming the incident beam into a sub-wavelength beam to expose and develop an object, comprising:
a transparent substrate, wherein the laser energy tolerance of the transparent substrate ranges from 8 J/cm² to 12 J/cm²; and
when the wavelength of the incident beam ranges from 100 nm to 400 nm, the light transmission of the transparent substrate is greater than 70 percent;
an opaque film, comprising a first surface and a second surface opposite to the first surface, wherein the transparent substrate adheres to the first surface; and
at least a sub-wavelength annular channel, formed in the opaque film and extending from the first surface to the second surface so that the incident beam from the transparent substrate generates a surface plasma wave on the opaque film.

2. The optical etching device for laser machining as claimed in claim 1, wherein the transparent substrate comprises melted quartz and melted sapphire blending SiO2.

3. The optical etching device for laser machining as claimed in claim 1, wherein the laser energy tolerance of the opaque film ranges from 8 J/cm² to 12 J/cm².

4. The optical etching device for laser machining as claimed in claim 3, wherein the opaque film comprises a silver film.

5. The optical etching device for laser machining as claimed in claim 1, further comprising a movable platform to change the relative position of the optical head and a photoresist layer of the object.

6. The optical etching device for laser machining as claimed in claim 1, wherein the sub-wavelength annular channel is ring-shaped.

7. The optical etching device for laser machining as claimed in claim 6, wherein the width of the sub-wavelength annular channel is 0.05 to 0.95 times the wavelength of the incident beam.

8. The optical etching device for laser machining as claimed in claim 1, further comprising a ring groove disposed on the inner side of the sub-wavelength annular channel on the opaque film, wherein the surface plasma wave generates light in the ring groove.

9. The optical etching device for laser machining as claimed in claim 8, wherein the sub-wavelength annular channel and the ring groove comprise a common center.

10. The optical etching device for laser machining as claimed in claim 8, wherein the ring groove is ring-shaped.

11. The optical etching device for laser machining as claimed in claim 8, wherein the depth of the ring groove is 0.05 to 0.5 times the wavelength of the incident beam.

12. The optical etching device for laser machining as claimed in claim 1, wherein the relative dielectric constant of the opaque film ranges from −2 to −32.

13. The optical etching device for laser machining as claimed in claim 1, wherein the relative dielectric constant of the opaque film ranges from +1.5 to +16.

14. The optical etching device for laser machining as claimed in claim 1, wherein the relative dielectric constant of the transparent substrate ranges from +1.5 to +16.

15. The optical etching device for laser machining as claimed in claim 1, wherein the thickness of the opaque film is 0.25 to 2 times the wavelength of the incident beam.
